(19) United States
(12) Patent Application Publication
(10) Pub. No.: US 2020/0250713 A1
(43) Pub. Date: Aug. 6, 2020

(54) Digital Signage System And Communication Slave Terminal

(71) Applicant: VACAN, INC., Tokyo (JP)

(72) Inventor: Takanobu KAWANO, Tokyo (JP)

(73) Assignee: VACAN, INC., Tokyo (JP)

(21) Appl. No.: 16/497,423

(22) PCT Filed: Mar. 13, 2018
(86) PCT No.: PCT/JP2018/009670

§ 371 Date: Sep. 24, 2019

(30) Foreign Application Priority Data
Apr. 7, 2017 (JP) 2017-076609

(51) Int. Cl. G06Q 30/02; G06Q 10/02; G09F 9/30; G09F 3/00

(52) U.S. Cl. CPC G06Q 30/0281; G09F 3/00; G09F 9/30; G06Q 10/02

(57) ABSTRACT

A digital signage system according to the present invention is a digital signage system including a digital signage, a digital signage control apparatus for distributing information to be displayed on the digital signage, and communication slave terminals, wherein the digital signage control apparatus includes a detection unit for detecting the number of vacant store facilities provided for users and a distribution unit for distributing vacant seat information based on the number of vacant store facilities to the digital signage. When the store facility is reserved, the communication slave terminal is provided on a surface of a table as equipment indicating a reserved state of said store facility, and transmits an ID of the reserved store facility and the number of users, the store facilities are tables and seats of a store, and the communication slave terminals are reservation tags to be provided on the tables.

### TECHNICAL FIELD

The present invention relates to a digital signage system and a communication slave terminal.

### BACKGROUND ART

Conventionally, a reservation management system used in a restaurant or the like is known (see, for example, Patent Documents 1 to 3). The restaurant staff operates the reservation terminal to access the reservation management system when the reservation is made. Then, the availability status is confirmed, and if there is an available seat, reservation information such as the number of reserved people and the reserved seat number is input on the system.

[Patent Document 1] Japanese Laid-Open Patent Application Publication No. 2009-153409

[Patent Document 2] Japanese Laid-Open Patent Application Publication No. 2009-153409

[Patent Document 3] Japanese Laid-Open Patent Application Publication No. 2009-153409

### DISCLOSURE OF INVENTION

### Problem to be Solved by Invention

However, if a reservation is made during busy hours such as during business hours, the restaurant staff may not have access to the reservation management system. In particular, in the case of a staff who is not good at operating the reservation terminal or a new staff, it takes a considerable amount of time to complete the reservation.

In addition, when guiding a store visitor to a seat, a reservation may be made depending on the seat, so the staff needs to refer to the reservation terminal at the reception to check whether the seat to be guided is a reservation. In the past, a reservation plate described as “reservation seat”, “reserved”, etc. was placed on the table of the reservation seat, so the seat reservation situation was intuitively apparent.

The present invention has been proposed in view of the above-described points, and an object of the present invention is to provide a system of vacant seat management that is intuitively easy to use.

### Means to Solve the Problem

In order to solve the above-mentioned problems, a digital signage system according to the present invention includes a digital signage, a digital signage control apparatus for distributing information to be displayed on the digital signage, and a communication slave terminal, wherein the digital signage control apparatus has detection means for detecting the number of vacant store facilities provided to a user, and distribution means for distributing vacant seat information based on the number of vacant store facilities to the digital signage, wherein when the store facilities are reserved, the communication slave terminal is installed in the store facilities as equipment indicating a reserved state of the store facilities, and transmits an identifier of the reserved store facilities or the number of users to the detection means, and the store facilities are a table and a seat of a store provided to a user, and the communication slave terminal is a reservation tag arranged on a tabletop of the table.

Further, in order to solve the above-mentioned problems, when the store facility provided to the user is reserved, the communication slave terminal according to the present invention is installed in the store facility as equipment indicating the reserved status of the store facility and transmits the number of the reserved store facility identifier or the number of users to the digital signage control apparatus for distributing the number of vacant store facilities to the digital signage, and the store facility is provided to the user. A table and a seat of the store where the communication slave terminal is a reservation tag disposed on the tabletop of the table.

### Advantage of the Invention

According to the embodiment of the present invention, it is possible to provide a vacant seat management mechanism that is intuitively easy to use.

### BRIEF DESCRIPTION OF DRAWINGS

FIG. 1 is a view showing a configuration example of a digital signage system according to an embodiment of the present invention.

FIG. 2 is a diagram showing an example of a hardware configuration of a control server according to the embodiment.

FIG. 3 is a view showing an external view 1 of the communication slave terminal according to the embodiment;

FIG. 4 is an external view 2 of the communication slave terminal according to the embodiment.

FIG. 5 is a view showing an example of an installation mode of the communication slave terminal according to the present embodiment.

FIG. 6 is a diagram showing an example of a hardware configuration of a communication slave terminal according to the present embodiment.

FIG. 7 is a view showing an example of the software configuration of a control server according to the embodiment.

FIG. 8 is a diagram showing an example of data of a vacant seat management DB according to the present embodiment.

FIG. 9 is a view showing an example of the store installation of the monitoring device according to the present embodiment.

FIG. 10 is a view showing an example of a store information new registration screen according to the embodiment.

FIG. 11 is a diagram showing an example of a seat setting screen according to the present embodiment.

FIG. 12 is a view showing an example of a seat detail setting screen according to the embodiment;

FIG. 13 is a view showing an example of a display screen of digital signage according to the embodiment.

FIG. 14 is a flowchart showing a process of updating vacant seat information by the control server according to the embodiment.

### BEST MODE FOR CARRYING OUT THE INVENTION

Embodiments will be described in detail with reference to the drawings.

<System Configuration>

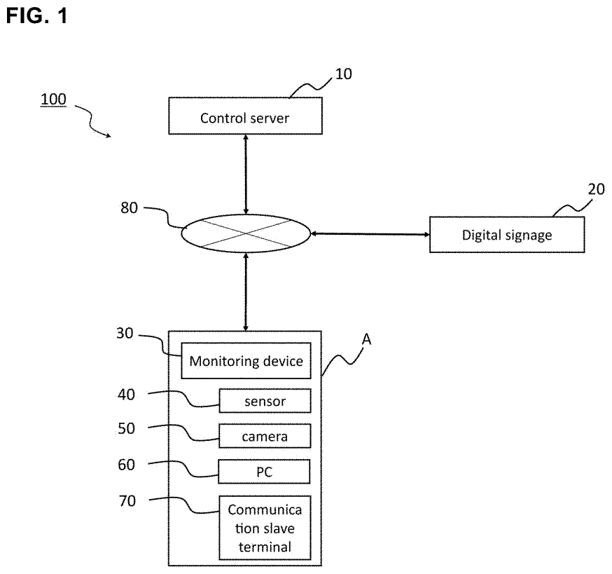

FIG. 1 is a diagram showing an example of the configuration of a digital signage system according to the present embodiment. The digital signage system 100 of FIG. 1 includes a digital signage control server (hereinafter referred to as a control server) 10, a digital signage 20, and a monitoring device 30, and is connected via a network 80.

The digital signage control server 10 is a device that distributes various contents such as a store's advertisement and vacant seat information to the digital signage 20. The various contents delivered are displayed on the display of the digital signage 20.

The digital signage 20 is an image display device such as a liquid crystal display installed on the outside (for example, a huge display), a storefront, an entrance of a complex commercial facility or building, a wall surface, or the like. The digital signage 20 is connected to the control server 10 on the cloud via the network 80, and displays delivery information such as store guidance information, advertisements, vacant seat information and the like as a signboard or a poster as an electronic signboard.

The monitoring device 30 is a device that monitors vacant seat information (vacant seat status) of a store or the like. It is installed in each monitoring target store (for example, store A, store B, . . . ).The monitoring device 30 is placed on a sensor 40 for detecting a human feeling, a camera 50 for image analysis of the presence of a person, a PC 60 used when a store clerk manually inputs setting information and vacant seat information, and a reservation desk It is connected to each vacant seat detection device such as a communication slave terminal 70 as a reservation plate, and transmits vacant seat information of a monitoring target store to the control server 10 on the cloud via the network 80.

The network 30 is a communication network including wired and wireless. The network 30 includes, for example, Internet, a public line network, WiFi (registered trademark), and the like.

<Hardware Configuration>

(Control Server)

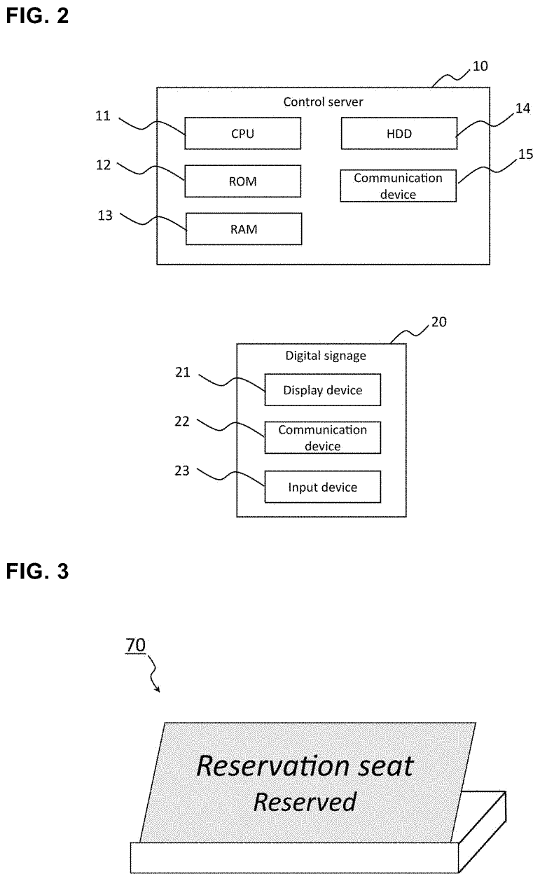

FIG. 2 is a diagram showing an example of the hardware configuration of the control server according to the present embodiment. As shown in FIG. 2, the control server 10 includes a central processing unit (CPU) 11, a read only memory (ROM) 12, a random access memory (RAM) 13, a hard disk drive (HDD) 14, and a communication device 15. Have.

The CPU 11 executes various programs and performs arithmetic processing. The ROM 12 stores programs and the like required at startup. The RAM 13 is a work area for temporarily storing the processing of the CPU 11 and storing data. The HDD 14 stores various data and programs. The communication device 15 communicates with other devices via the network 80.

The digital signage 20 includes a display device 21, a communication device 22, and an input device 23.

The display device 21 is a color display realized by a liquid crystal display, a plasma display, an LED display, or the like. The communication device 22 is a device for performing information communication with an external device. The input device 27 is realized by unique operation keys, buttons, and the like. In addition, the input device 27 can be realized by a touch panel that can detect the tap coordinates (touch coordinates) on the display screen instead of the operation keys and buttons. In this case, the input operation is realized by the touch panel on the screen and a software key etc., controlled by the program.

(Communication Slave Terminal)

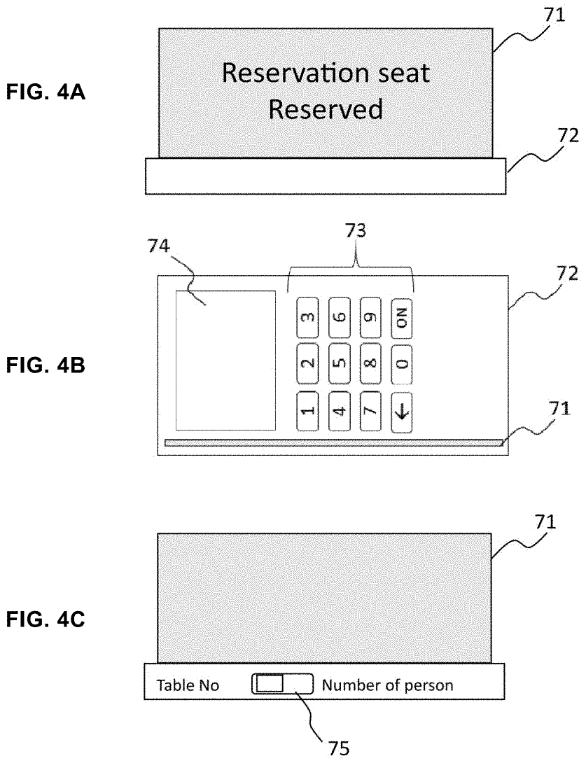

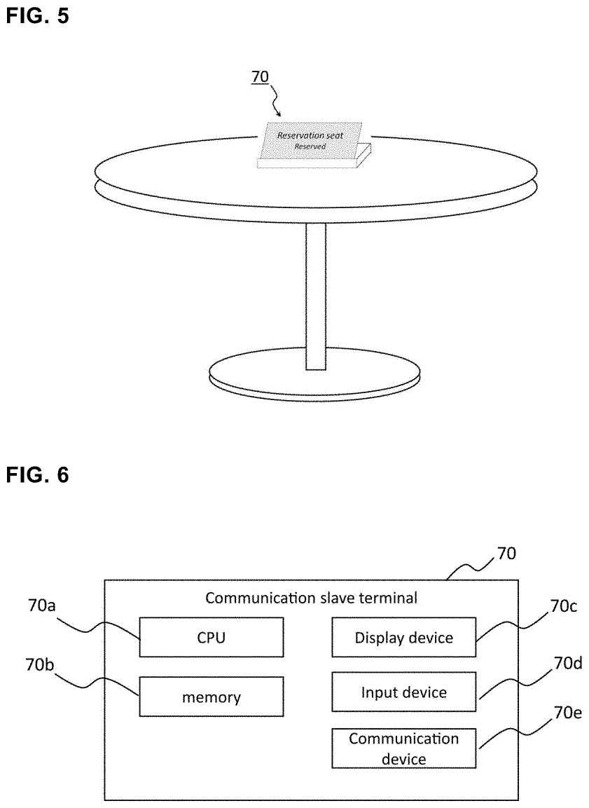

FIG. 3 is a view showing an appearance view 1 of the communication slave terminal according to the present embodiment. FIG. 4 is an external view 2 of the communication slave terminal according to the present embodiment. (a) shows a front view, (b) shows a plan view, and (c) shows a rear view. FIG. 5 is a diagram showing an example of the installation mode of the communication slave terminal according to the present embodiment.

The communication slave terminal 70 of FIGS. 3 and 4 displays a plate 71 displayed as “Reserved seat (Reserved)”, a housing 72, an input button 73 for inputting a table number and the number of users, and input information and the like. It has a display 74 and an input switch 75 for switching the input of either the table number or the number of users.

The communication slave terminal 70 is used as a reservation plate (also referred to as a reservation tag) placed on the table of the reservation seat. A plurality of communication slave terminal 70 are prepared in advance as fixtures in the store, and when a reservation is made, the staff of the store arranges the communication slave terminals 70 on the table of the reserved table.

Next, the store staff performs a predetermined operation in the communication slave terminal 70 disposed on the tabletop of the table. Specifically, first, the input switch 75 is set to the “table number”, the input button 73 is operated, the table number of the reserved table is input, and the transmission button (ON) is used to transmit to the monitoring device 30. Alternatively, the input changeover switch 75 is set to “number of persons”, the input button 73 is operated, the number of reserved users (number of reserved users) is input and transmitted to the monitoring device 30 by the transmission button (ON).

Once the table number and the number of users is set in advance, it is possible to transmit the setting to the monitoring device 30 simply by turning on the power switch (not shown) without performing the predetermined operation each time. is there. The store side prepares, for example, a communication slave terminal 70 for a large table and a communication slave terminal 70 for a four-person table in advance.

FIG. 6 is a diagram showing an example of a hardware configuration of a communication slave terminal according to the present embodiment. As shown in FIG. 6, the communication slave terminal 70 includes a CPU 70a, a memory 70b, a display device 70c, an input device 70d, and a communication device 70e.

The CPU 70a executes various programs and performs arithmetic processing. The memory 70b is a storage device that stores various control programs and input data.

The display device 70c is a display. The input device 27 is realized by unique operation keys, buttons, and the like. The input device 70d may be realized by a touch panel capable of detecting tap coordinates (touch coordinates) on the display screen, instead of the operation keys and buttons. In this case, the input operation is realized by the touch panel on the screen and a software key etc., controlled by the program.

The communication device 70e is a device for performing wireless communication with the monitoring device 30.

<Software Configuration>

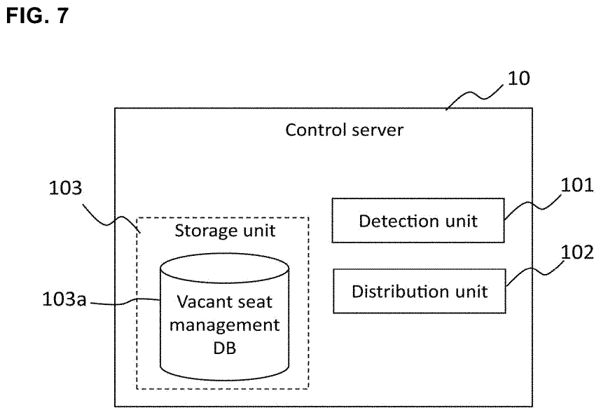

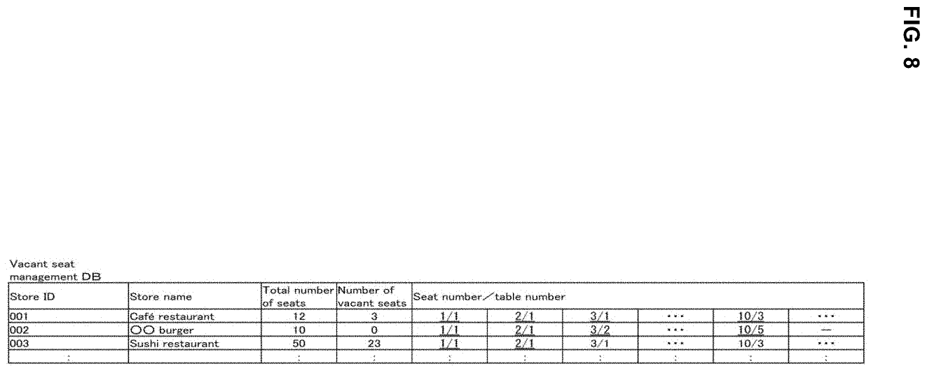

FIG. 7 is a diagram showing an example of the software configuration of the control server according to the present embodiment. The control server 10 includes a detection unit 101, a distribution unit 102, and a storage unit 103 as main functional units.

The detection unit 101 has a function of detecting the number of vacant store facilities provided to the user.

The distribution unit 102 has a function of distributing, to the digital signage 20, vacant seat information based on the number of vacant spaces of the store facility detected by the detection unit 101.

The storage unit 103 has a function of storing the vacant seat management DB 103a. The vacant seat management DB 103a is a database for managing vacant seat information (vacant seat status) of a store in real time.

The functional unit is realized by a computer program executed on hardware resources such as a CPU, a ROM, and a RAM of the computer constituting the control server 10. The functional units may be replaced by “means”, “module”, “section”, or “circuit”.

(Vacancy Management DB)

FIG. 8 is a view showing an example of data of a vacant seat management DB according to the present embodiment. The vacant seat management DB 103a is a database for managing vacant seat information (vacant seat status) of a store in real time. The vacant seat management DB 103a has, for example, data items such as “store ID”, “store name”, “total number of seats”, “number of vacant seats”, and “seat number/table number”.

“Store ID” indicates a unique identifier numbered for each store.

“Store name” indicates the name of the store.

“Total number of seats” indicates the total number of seats in the store.

“Number of vacant seats” indicates the number of vacant seats in “total number of seats”. “The number of vacant seats fluctuates in real time according to the availability.

The “seat number/table number” indicates the number of the seat installed in the store and the table number corresponding to the seat. For example, in the case of a store having a total number of seats of 50, each seat is registered in fixed association with “seat number” 1 to 50. In addition, each table is fixedly registered in each “seat number” 1 to 50.

In the vacant seat management DB 103a, the actual vacant seat status (status) is managed in real time for each seat. For example, in the case of FIG. 8, a seat whose “seat number/table number” is underlined indicates a non-vacant state (seated state) or a reserved state. Therefore, the above-mentioned “number of vacant seats” is equal to the total number of seats in normal display that are not underlined.

<Example of Installation>

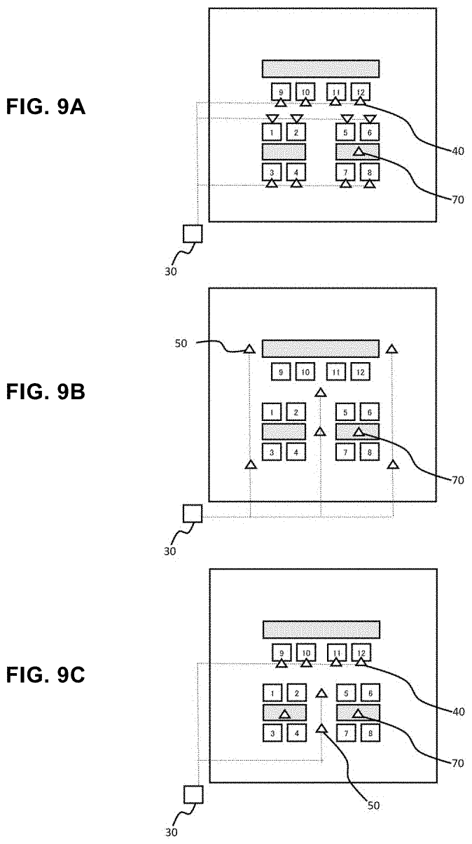

FIG. 9 is a view showing an example of the store installation of the monitoring device according to the present embodiment. The monitoring device 30 is a device that monitors vacant seat information (vacant seat status) of a store or the like. The monitoring device 30 is installed at any place in the store. Further, the monitoring device 30 is communicably connected to a vacant seat detection device such as the sensor 40, the camera 50, the PC 60, and the communication slave terminal 70 via a wireless (or wired) network in the store.

Here, as for the communication slave terminal 70 in the figure, when a reservation is made, it is placed on the table of the table containing the reservation each time. When a reservation is made, the staff of the store places the communication slave terminal 70 on the tabletop of the table, and operates the communication slave terminal 70.The monitoring device 30 detects that the seat is in the reserved state based on the table number or the information of the number of users transmitted from the communication slave terminal 70, and the store ID, the table number or the number of users, and the seats Information is transmitted to the control server 10 indicating that the reserved state has been reached.

FIG. 9A shows an example in which the sensor 40 is used as a vacant seat detection device. In the case of FIG. 9A, as an example, the store is provided with a total of 12 seats of seat numbers 1 to 12, and the sensor 40 is installed in each seat.

A sensor 40 is installed at each seat to detect the seating of the user. Information monitoring device 30, shown when the seat based on the detection signal of the sensor over 40 detects that became non vacant state (i.e., seated state), the store ID, and the seat number and the seat becomes non vacant state are sent to the control server 10. Further, the sensor 40 detects the absence of the user. When the monitoring device 30 detects that the seat is vacant based on the non-detection signal of the sensor 40, it transmits the store ID, the seat number, and information indicating that the seat is vacant to the control server 10.

FIG. 9B shows an example in which the camera 50 is used as a vacant seat detection device. In the case of FIG. 9B, one or more cameras 50 are installed on the store ceiling or the like. The store is provided with a total of 12 seats of seat numbers 1 to 12, and the camera 50 covers the entire seat in the imaging range.

The camera 50 captures an image of all the seats in real time, and the captured image is input to the monitoring device 30 one by one. When the monitoring device 30 detects that the seat is in the non-vacant state based on the processing result of the image analysis, the store ID, the seat number, and the information indicating that the seat is in the non-vacant state (that is, the seating state), To the control server 10. In addition, when the monitoring device 30 detects that the seat is vacant based on the processing result of the image analysis, the store ID, the seat number, and the information indicating that the seat is vacant are sent to the control server 10 It transmits via the network 80.

FIG. 9C shows an example in which the sensor 40 and the camera 50 are used in combination as a vacant seat detection device. In the case of FIG. 5C, the sensor 40 is installed in each seat of the store, and one or more cameras 50 are used. Are installed on store ceilings. In addition, the store is provided with a total of 12 seats with seat numbers 1 to 12. For example, for convenience of a store or a seat, it is preferable that the camera 50 covers a seat (for example, a table seat etc.) where it is more efficient to install the camera 50.

It is noted that the PC 60 may be used as a vacant seat detection device in place of or in combination with the sensor 40, the camera 50, and the communication slave terminal 70. When the PC 60 is used, a store clerk operates the PC 60 and inputs the availability status confirmed visually or the like into the monitoring device 30. The monitoring device 30 transmits, to the control server 10, information indicating that the store ID, the seat number, and the seat are in the non-vacant state when the seat is in the non-vacant state (that is, the seating state) is input. In addition, when it is input that the seat is vacant, the monitoring device 30 transmits, to the control server 10, a store ID, a seat number, and information indicating that the seat is vacant.

Further, when the reservation person visits and the seat of the reservation seat is actually seated, the staff of the store removes the communication slave terminal 70 from the tabletop of the table, but this time the sensor 40 or the camera 50 detects the seating of the user.

In addition, when the monitoring device 30 according to the present embodiment is not installed, the sensor 40, the camera 50, the PC 60, and the communication slave terminal 70 do not have the store ID, the seat number, and the seat empty for the control server 10. It is also possible to directly transmit information indicating that the seat is vacant.

<Screen>

(New Registration of Store Information)

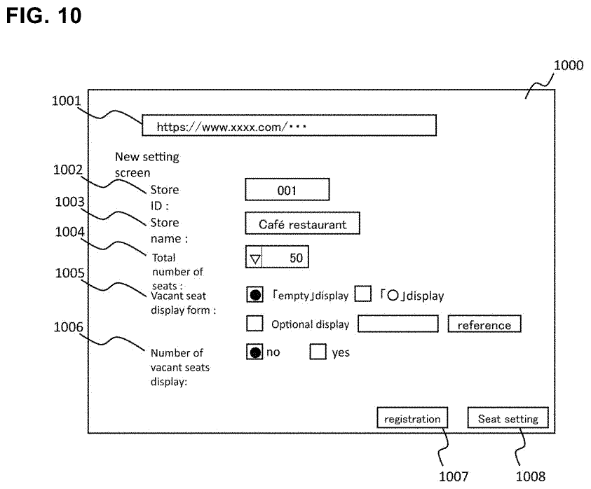

FIG. 10 is a diagram showing an example of a store information new registration screen according to the present embodiment. First, the store clerk accesses the new registration screen 1000 of the control server 10 using the PC 60 or the like.

The URL 1001 is a field for inputting location information (for example, a domain, an IP address, etc.) of the control server 10.

The store ID 1002 indicates a unique identifier numbered for each store. The store ID given in advance from the control server 10 is input or automatically issued to the store at the time of registration.

The store name 1003 is a field for entering the name of the store.

The total number of seats 1004 is a field for entering the total number of seats in the store.

The vacant seat display form 1005 is a field for setting the form for displaying vacant seat information of a store on the digital signage 20. For example, when “Display empty” is checked, the vacant seat display is displayed as “empty”. “When the “display” is checked, the vacant seat display is displayed by a symbol such as “∘”, “Δ”, “×”. In addition, when “optional display” is checked, the vacant seat display is displayed with any character, symbol or image specified by the store representative, such as “I'm free now”. The person in charge inputs file data of any character, symbol or image.

The number of vacant seats display 1006 is a field for setting whether or not to display the remaining number of vacant seats when displaying the vacant seat information of the store on the digital signage 20. If “Yes” is checked, the number of remaining vacant seats is displayed on the digital signage 20 together with vacant seats such as “Sky” and “O”.

The registration 1007 is a registration button for registering input information.

The seat setting 1008 is a button for setting the seat (see FIG. 7 described later).

As described above, the input information input on the new registration screen 1000 is stored in the vacant seat management DB 103a (see FIG. 8).

(Seat Setting)

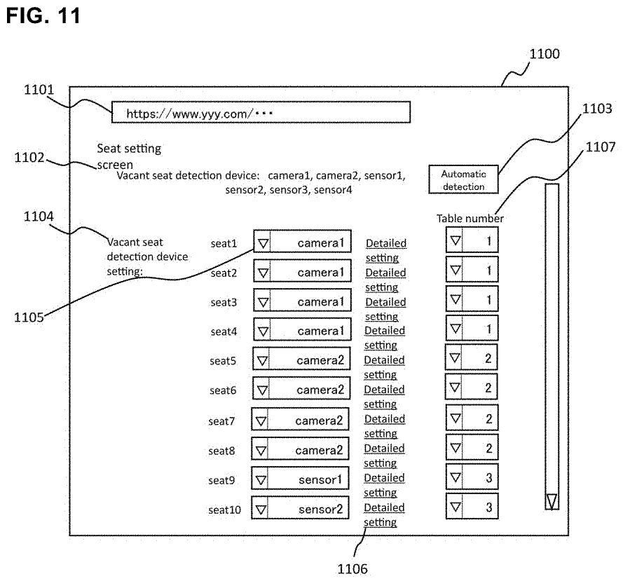

FIG. 11 is a diagram showing an example of a seat setting screen according to the present embodiment. After installing the monitoring device 30, the sensor 40 and the camera 50, the store clerk uses the PC 60 to access the seat setting screen 1100 of the monitoring device 30 (or the control server 10).For convenience of explanation, the seat setting screen 1100 of FIG. 11 will be described with reference to the example of FIG. 9 (C).

The URL 1101 is a field for inputting location information of the monitoring device 30.

The vacant seat detection device 1102 registers the sensor 40, the camera 50, and the PC 60 installed in the store. The vacant seat detection device 702 is reflected in a selection field 1105 described later.

The automatic detection 1103 is a button for automatically detecting the sensor 40 and the camera 50 installed in the store. When the automatic detection 1103 is pressed, the monitoring device 30 searches for sensors 40 and cameras 50 present in the in-store network using a predetermined network protocol.

The vacant seat detection device setting 1104 is a setting field that associates each seat of the store with each vacant seat detection device. For example, the camera 1 is selected from the selection column 1105 as an empty seat detection device for detecting empty seats of the seats 1 to 4. The camera 2 is selected from the selection column 1105 as an empty seat detection device for detecting empty seats of the seats 5 to 8. Also, as empty seat detection devices for detecting empty seats in the seats 9, 10, 11, 12, the sensors 1, 2, 3, 4 are selected from the selection column 1105, respectively.

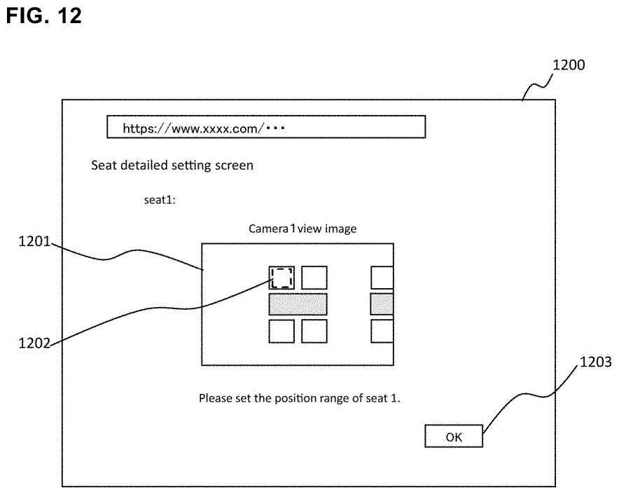

The detailed setting 1106 is a button for performing detailed setting of the seat detection device (see FIG. 12 described later).

The table number 1107 indicates the seat table number. It is a setting field which matches each seat of a store, and each table where a seat is installed. For example, the seats 1 to 4 correspond to the table of the table number 1. Similarly, the seats 5 to 8 correspond to the table of the table number 2, and the seats 9 to 12 correspond to the counter table of the table number 3.

(Detailed Setting of the Seat)

FIG. 12 is a diagram showing an example of a seat detailed setting screen according to the present embodiment. In the seat setting screen 1100, when the detailed setting 1106 (see FIG. 11) of the seat 1 is pressed, the screen is changed to the seat detailed setting screen 1200 of FIG. 12.

The camera view screen 1201 displays a captured image (video) of the camera 1 associated with the seat 1. The administrator designates a range 1202 in which the seat 1 is positioned among the captured images (videos) of the camera 1 with a mouse or the like and presses an OK 1203.

The camera 50 can detect the availability of a plurality of seats present in one captured image. Here, in the case of detecting the vacant seat status of a plurality of seats by one camera 50, it is necessary to uniquely associate a seat with the “seat number” of the seat in advance. Thus, for example, when the monitoring device 30 detects that the user is seated in the range 1202 in the captured image of the camera 1, it detects that the seat 1 is in the non-empty state (seated state).

<Display Screen Example of Digital Signage>

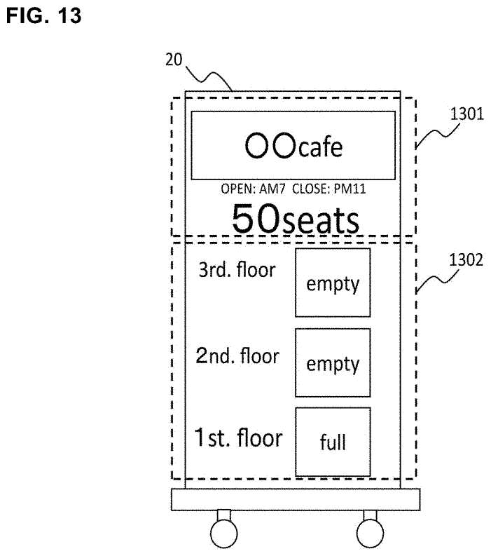

FIG. 13 is a view showing an example of a display screen of digital signage according to the present embodiment. The digital signage 20 shown in FIG. 13 is disposed in a position that is easily visible to the user from outside the store, such as near the entrance of the store.

On the display screen of the digital signage 20, the display area 1301 displays the logo of the store distributed from the control server 10, sales guidance and the like. By appealing the store's signboard, the user's interest is kept.

In the display area 1302, the vacant seat information of the store distributed from the control server 10 is displayed in a vacant seat display form of “empty” and “full”. The availability status is displayed in real time, so you can see the current status at a glance. In the case of “Empty” in particular, by appealing vacancies in real time, it encourages users who have noticed their eyes to enter immediately without waiting.

When selecting a restaurant, some users may select a restaurant based on a desire to “enter the store immediately”, “whether or not there is a seat”, and “do not want to wait”.

The user is interested by the signboard of the store of the digital signage 20, and it can be understood that the store has vacant seats at a glance. Therefore, since the user can be seated immediately after entering the store without waiting, the user can enter the store with confidence. When the user tried to go into the store with his or her feet, the user never had the experience of not having a seat (it was not full).

As described above, when there is a vacant seat, the store side wants to fill the seat more positively as there are more vacant seats, but by displaying the vacant seat information in real time on the digital signage 20 in real time, the store enters without waiting. You can appeal effectively what you can do.

Here, when the seat is reserved as described above, the communication slave terminal 70 is arranged on the tabletop of the reserved table. If a reservation is made, it is necessary to secure a seat for the reservation person, and such a seat cannot be treated as a vacant seat. Therefore, when the communication slave terminal 70 is arranged, the table number of the table reserved by the communication slave terminal 70 or the number of users is transmitted to the monitoring device 30 and the control server 10, and the vacant seat status including the reserved seat is displayed. It is possible to display in real time.

In addition, when the seat in the store has a reservation, since the communication slave terminal 70 is placed on the tabletop in the reservation seat, when the store staff guides the reservation person who visits to the seat, it is intuitive to recognize the reserved seat to guide. Of course, the user will not accidentally pass another user to the reserved seat. Double booking of reservations can also be easily prevented.

<Information Processing>

(Update Processing of Vacant Seat Information)

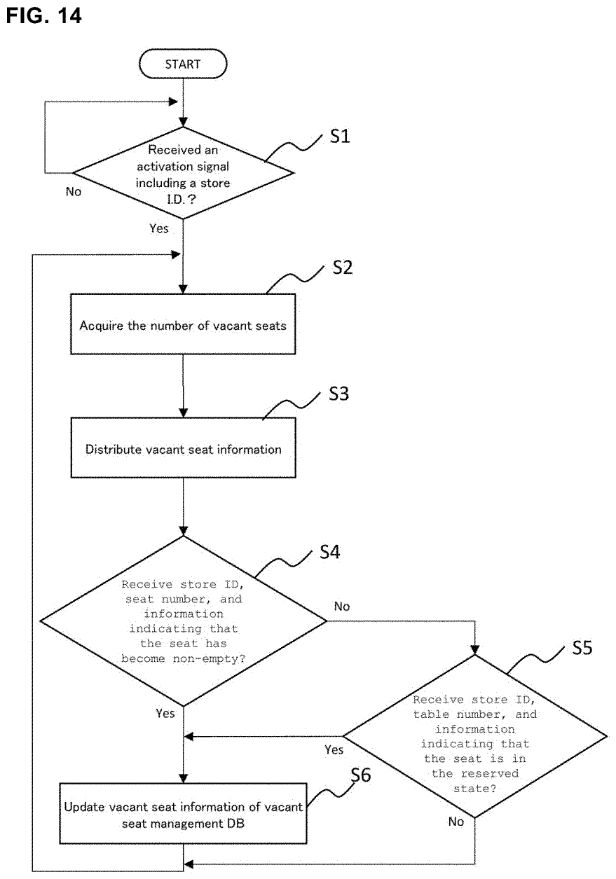

FIG. 14 is a flowchart showing the process of updating vacant seat information by the control server according to the present embodiment.

S1: The control server 10 determines whether or not an activation signal including a store ID has been received from the monitoring device 30. The monitoring device 30 transmits a start signal including a store ID to the control server 10 at the time of start.

S2: The control server 10 refers to the vacant seat management DB 103a to acquire the “number of vacant seats” corresponding to the store ID included in the activation signal of S1.

S3: The control server 10 delivers, to the digital signage 20, vacant seat information based on the signboard of the store and the “number of vacant seats” (FIG. 13). In addition, as for the signboard of the store, for example, an image or a video of the signboard specified by the store may be distributed. Vacant seat information is distributed in a form according to the vacant seat display form 1005 and the vacant seat number display 1006 based on the “number of vacant seats” acquired in S2 (FIG. 10).

S4: Next, the control server 10 determines whether or not the store ID, the seat number, and information indicating that the seat has become non-empty is received from the monitoring device 30. If it is received, the process proceeds to S6, and if it is not received, the process proceeds to S5. As described above, when the monitoring device 30 detects that the seat is in the non-vacant state based on the detection signal of the vacant seat detection device, the store ID, the seat number, and the information indicating that the seat is in the non-vacant state are sent to the control server 10.

S5: The control server 10 determines whether or not the store ID, the table number or the number of users, and the information indicating that the seat has been reserved has been received. If it is received, the process proceeds to S6. If it is not received, the process proceeds to S2.

S6: The control server 10 updates the vacant seat information. Specifically, it is as follows.

That is, when the store ID, the seat number, and the information indicating that the seat is in the non-vacant state are received in S4, the availability of the seat identified by the seat number is determined in the store identified by the store ID., change from an empty seat state to a non-empty seat state (for example, “seat number” in FIG. 8 is underlined). Further, the “number of vacant seats” is updated by subtracting the number of seats changed to the non-vacant seat state from the “number of vacant seats”.

On the other hand, when the store ID, the table number, and the information indicating that the seat is in the reserved state are received in S5, the table number shown in FIG. The seat number associated with the number 1107 is identified, and the vacant seat status of the seat identified by the seat number is changed from the vacant seat state to the non-vacant seat state (for example, “seat number” in FIG. 8 is underlined). Further, the “number of vacant seats” in FIG. 8 is updated by subtracting the number of seats changed to the non-vacant seat state from the “number of vacant seats”.

When the store ID, the number of users, and the information indicating that the seat is in the reserved state are received in S5, the user who received from the “number of vacant seats” in the store specified by the store ID By subtracting the number, the “number of vacant seats” in FIG. 8 is updated. In the case where the number of users is received, although it is obvious that “the number of vacant seats” is reduced by the reserved seat, it is not possible to determine which seat number the seat is to be changed to the non-vacant seat state. It is assumed that the change from the vacant seat state to the non-vacant seat state is not performed (for example, the “seat number” in FIG. 8 is not underlined).That is, while securing the number of seats for the number of users, it will be in the state which has not allocated to a specific seat.

Proceeding to S2 again, vacant seat information based on the updated number of vacant seats is distributed.

<Summary>

As described above, in the digital signage system 100 according to the present embodiment, when a reservation is made, the communication slave terminal 70 as a reservation plate displayed as “Reserved seat (Reserved)” is placed on the table desk of the reservation seat each time. It is eaten.

Therefore, when the seat in the store has a reservation, since the communication slave terminal 70 is placed on the tabletop table in the reservation seat, when the store staff guides the reservation person who visits to the seat, it is intuitive It can be recognized to be guided reservation seat. The staff will not accidentally pass another user to the reserved seat. Double booking of reservations can also be easily prevented.

In addition, the control server 10 detects the number of vacant seats in the store provided to the user based on the table number or the information on the number of users transmitted via the communication slave terminal 70 and the monitoring device 30 as the master device. The vacant seat information including reserved seats is distributed to the digital signage 20 in real time. As a result, the store side wants to fill in vacant seats as much as possible when there are many vacant seats, but it is possible to encourage users to positively enter stores and fill up vacant seats.

That is, according to the digital signage system 100 according to the present embodiment, it is possible to provide a vacant seat management mechanism that is intuitively easy to use.

While the present invention has been described in terms of specific embodiments and in accordance with the preferred embodiments of the invention, those embodiments may be practiced without departing from the broad spirit and scope of the invention as defined in the appended claims. Obviously, various modifications and variations can be made to the example. That is, the present invention should not be construed as being limited by the details of the specific examples and the attached drawings.

For example, the equipment provided to the user such as a store is not limited to only the seat of the store according to the present embodiment and may be any equipment having a limited number available to the user. For example, it may be a private room of a restaurant, a karaoke box, a manga cafe sheet, a loan product, a game machine of a game arcade, a meeting room, a coworking space, or the like.

Also, the digital signage system 100, the digital signage control server 10 and the digital signage 20 according to the present embodiment are, for example, dynamic signage, interactive signage, narrow casting, video delivery, audio delivery, digital POP, digital signature, Digital billboards, digital display signage, digital content distribution systems, electronic POPs, electronic posters, electronic boards, electronic information boards, electronic displays, electronic signboard systems, electronic bulletin boards, electronic advertising boards, and the like.

### DESCRIPTION OF REFERENCE SYMBOLS

10 Digital Signage Control Server

20 Digital Signage

30 monitoring device

40 sensors

50 cameras

60 pcs

70 Communication slave terminal

100 Digital Signage System

101 detection unit

102 Distribution Department

103 storage unit

1. A digital signage system, comprising:
a digital signage;
a digital signage control apparatus configured to distribute information to be displayed on the digital signage; and
communication slave terminals,
wherein the digital signage control apparatus includes,
a detection unit configured to detect a vacant number of store facilities to be provided to a user; and
a distribution unit configured to distribute vacant seat information in accordance to the vacant number of the store facilities to the digital signage,
wherein, when the store facility is reserved, the communication slave terminal is provided on a tabletop of a table as equipment indicating a reserved state of said store facility, and transmits an ID of the reserved store facility and the number of users,
wherein the store facilities are tables and seats of a store, and
wherein the communication slave terminals are reservation tags to be provided on the tables.

2. The digital signage system claimed in claim 1, wherein the communication slave terminals each include an input part for inputting the ID of the reserved store facility and the number of the users.

3. The digital signage system claimed in claim 1, wherein the detection unit, in response to a reception of the ID of the reserved table from the communication slave terminal, subtracts the number of seats corresponding to the table from the number of vacant seats.

4. A communication slave terminal configured to be provided on a store facility as equipment indicating a reserved state of the store facility, and transmit an ID of the reserved store facility and the number of users, when the store facility is reserved,
wherein the store facilities are tables and seats of a store, and
wherein the communication slave terminal is a reservation tag to be provided on a tabletop of the table.

5. The communication slave terminal claimed in claim 4, comprising an input part for inputting the ID of the reserved store facility and the number of the users.
